(19) United States
(12) Patent Application Publication
(10) Pub. No.: US 2012/0102190 A1
(43) Pub. Date: Apr. 26, 2012

(54) INTER-VIRTUAL MACHINE COMMUNICATION

(75) Inventors: Pamela C. Durham, Apex, NC (US); Nils Peter Joachim Hansson, Monroe, WA (US); Edward S. Suffern, Chapel Hill, NC (US); James L. Wooldridge, Fall City, WA (US)

(73) Assignee: INTERNATIONAL BUSINESS MACHINES CORPORATION, Armonk, NY (US)

(21) Appl. No.: 12/911,832

(22) Filed: Oct. 26, 2010

(51) Int. Cl. G06F 15/173; G06F 9/455

(52) U.S. Cl. 709/224; 718/1

(57) ABSTRACT

A computer implemented method is provided, including monitoring network traffic among virtual machines that are allocated to a plurality of compute nodes on a network, and identifying first and second virtual machines having inter-virtual machine communication over the network in an amount that is greater than a threshold amount of the network traffic. The method further comprises migrating at least one of the first and second virtual machines so that the first and second virtual machines are allocated to the same compute node and the inter-virtual machine communication between the first and second virtual machines is no longer directed over the network. In one embodiment, each compute node is coupled to an Ethernet link of a network switch, and data is obtained from a management information database of the network switch to determine the amount of network bandwidth that is being utilized for communication between the first and second virtual machines.

### BACKGROUND

1. Field of the Invention

The present invention relates to the management of virtual machines. More specifically, the present invention relates to management of the system resources in a virtual machine environment.

2. Background of the Related Art

In a cloud computing environment, a user is assigned a virtual machine somewhere in the computing cloud. The virtual machine provides the software operating system and has access to physical resources, such as input/output bandwidth, processing power and memory capacity, to support the user's application. Provisioning software manages and allocates virtual machines among the available computer nodes in the cloud. Because each virtual machine runs independent of other virtual machines, multiple operating system environments can co-exist on the same physical computer in complete isolation from each other.

### BRIEF SUMMARY

One embodiment of the present invention provides a computer-implemented method, comprising monitoring network traffic among virtual machines that are allocated to a plurality of compute nodes on a network, and identifying first and second virtual machines having inter-virtual machine communication over the network in an amount that is greater than a threshold amount of the network traffic. The method further comprises migrating at least one of the first and second virtual machines so that the first and second virtual machines are allocated to the same compute node and the inter-virtual machine communication between the first and second virtual machines is no longer directed over the network.

### BRIEF DESCRIPTION OF THE SEVERAL VIEWS OF THE DRAWINGS

FIG. 1 depicts an exemplary computer that may be utilized in accordance with the present invention.

FIG. 2 illustrates an exemplary blade chassis that may be utilized in accordance with the present invention.

FIG. 3 depicts another embodiment of the present disclosed method utilizing multiple physical computers in a virtualized rack.

FIG. 4 is a table illustrating network traffic data obtained from network switches and maintained by a management node.

FIG. 5 is a block diagram illustrating the migration of a virtual machine from one server to another.

FIG. 6 is a flowchart of a method of the present invention.

### DETAILED DESCRIPTION

One embodiment of the present invention provides a computer-implemented method, comprising monitoring network traffic among virtual machines that are allocated to a plurality of compute nodes on a network, and identifying first and second virtual machines having inter-virtual machine communication over the network in an amount that is greater than a threshold amount of the network traffic. The method further comprises migrating at least one of the first and second virtual machines so that the first and second virtual machines are allocated to the same compute node and the inter-virtual machine communication between the first and second virtual machines is no longer directed over the network.

In a further embodiment, the compute node is coupled to an Ethernet link of a network switch, and data is obtained from a management information database of the network switch to determine the amount of network bandwidth through the Ethernet link that is being utilized for communication between the first and second virtual machines. Communications between two virtual machines may be referred to as “inter-virtual machine” communications or “inter-VM” communications. In systems having virtual machines on multiple compute nodes, inter-VM communications cause network traffic. The network switch collects network statistics in its management information base (MIB). Optionally, the MIB data may be used to identify the amount of network bandwidth attributable to communications between the first and second virtual machines and is identified according to media access control (MAC) addresses or Internet Protocol (IP) addresses that are assigned to the first and second virtual machines. For example, the MIB data may identify, or be used to identify, network traffic associated with a MAC couplet that represents the two virtual machines. Therefore, both the MAC address of the originating VM and the MAC address of the destination VM may be recorded in association with the network traffic between the two VMs. Data from each network switch MIB may be shared with a management node in each chassis and/or shared directly with the remote management node. Whether the remote management node obtains the network traffic data directly or from the chassis management nodes, the remove management entity has access to all inter-VM network traffic data. Optionally, virtual machines having the highest inter-virtual machine communication may be ranked, perhaps from highest to lowest inter-VM network traffic, to facilitate identification of an appropriate VM to migrate.

In various embodiments of the invention, inter-VM traffic can be managed at the overall network level or within the overall network, such as at the IP subnet level, because the IP address associated with network traffic can also be identified. It may be easier to manage the IP sublevel since a router (a device able to connect two different subnets together) is not required. Accordingly, the MIB can use the IP address of a virtual machine across the entire network. If the network contains only one subnet, then it may be simpler to use a MAC address associated with each virtual machine since the MAC address is an ISO layer 2 entity whereas the IP address is a layer 3 entity.

Network traffic may be reduced by placing two virtual machines having high inter-VM network traffic onto the same physical compute node. Accordingly, the method includes migrating at least one of the first and second virtual machines. In one option, the migration includes migrating the first virtual machine from a first compute node to a second compute node that is running the second virtual machine. However, it is possible that the first and second compute nodes will have an insufficient amount of unused resources to accommodate an additional virtual machine. In another option, the migration includes migrating both the first and second virtual machines to a compute node, such as a third compute node, having sufficient resources available to accommodate both of the first and second virtual machines.

In another embodiment, the computer implemented method further comprises calculating a value that is representative of the inter-virtual machine communication between the first and second virtual machines over a period of time. Non-limiting examples of such a representative value include an average bandwidth, mean bandwidth, and standard deviation of the bandwidth over a period of time. Accordingly, the first and second virtual machines may be identified as those virtual machines having a representative value of inter-virtual machine communication that is greater than a threshold value. Using a representative value, rather than an instantaneous value, will avoid migrating a VM as the result of a short duration peak of inter-VM network traffic.

In a still further embodiment, the computer implemented method further comprises determining that the second compute node has sufficient unused resources to operate the first virtual machine. This determination may include reading the vital product data (VPD) of the second compute node to determine the input/output capacity, the processor capacity, and the memory capacity of the second compute node. Still further, the processor utilization and the memory utilization may be obtained directly from the second compute node. The amount of an unused resource can be calculated by subtracting the current utilization from the capacity of that resource for a given compute node, such as a server.

Yet another embodiment of the computer implemented method, further comprises determining an amount of unused resources on a first compute node operating the first virtual machine and an amount of unused resources on a second compute node operation the second virtual machine, determining the resource requirements of the first and second virtual machines, and selecting between migrating the first virtual machine to the second compute node and migrating the second virtual machine to the first compute node so that the utilization of resources after migration is most evenly distributed between the first and second compute node.

It should be recognized that the threshold amount of network traffic, which is used in identifying first and second virtual machines, may be stated as an absolute amount of bandwidth or as a percentage of the link bandwidth of the compute node. For example, an absolute threshold amount might be 100 Mbps and a percentage threshold amount might be 25% of the link bandwidth.

A remote management node may be responsible for identifying the first and second virtual machines having inter-virtual machine communication over the network in an amount that is greater than a threshold amount of the network traffic. In accordance with various embodiments of the invention, the remote management node gathers network statistics from the MIBs of network switches in the network and is able to determine which virtual machines have the highest inter-VM network traffic. The remote management node may then initiate an appropriate migration of at least one of the first and second virtual machines so that those two virtual machines reside on the same physical server. With the two virtual machines operating simultaneously on a single physical server, the inter-VM communication between those VMs does not exit the physical server and reduces or eliminates its contribution to network traffic.

In the context of this application, virtual machines may be described as requiring various amounts of resources, such as input/output capacity, memory capacity, and processor capacity. However, it should be recognized that the amount of the resources utilized by a virtual machine is largely a function of the software task or process that is assigned to the virtual machine. For example, computer-aided drafting and design (CADD) applications and large spreadsheet applications require heavy computation and are considered to be processor intensive while requiring very little network bandwidth. Web server applications use large amounts of network bandwidth, but may use only a small portion of memory or processor resources available. By contrast, financial applications using database management require much more processing capacity and memory capacity with a reduced utilization of input/output bandwidth.

In yet another embodiment, the method further comprises obtaining the processor utilization and the memory utilization of the compute node directly from the compute node. Those skilled in the art will realize that this information is available from the hypervisor task manager which obtains the memory required and the CPU utilization from all the processes executing on the physical compute node. The processor and memory utilization indicates the amount of processor and memory capacity that is currently in use or, conversely, allows the determination of the amount of processor and memory capacity that is not currently in use. It is therefore possible to determine, either as part of the virtual machine selection process or at least prior to migrating, that the target compute node has sufficient unused processor and memory capacity to run the additional virtual machine.

In conjunction with various embodiments of the method, it is also possible to determine the input/output capacity, the processor capacity, and the memory capacity of the compute node by reading the vital product data of the compute node. Subtracting the input/output utilization, the processor utilization, and the memory utilization from the input/output capacity, the processor capacity, and the memory capacity, respectively, yields the unused amount of each of these resources. Accordingly, the input/output requirements, the processor requirements, and the memory requirements of the virtual machines can be compared with the unused amount of resources on a particular compute node to identify that a particular virtual machine can be accommodated on a particular compute node without over-allocating any of the resources.

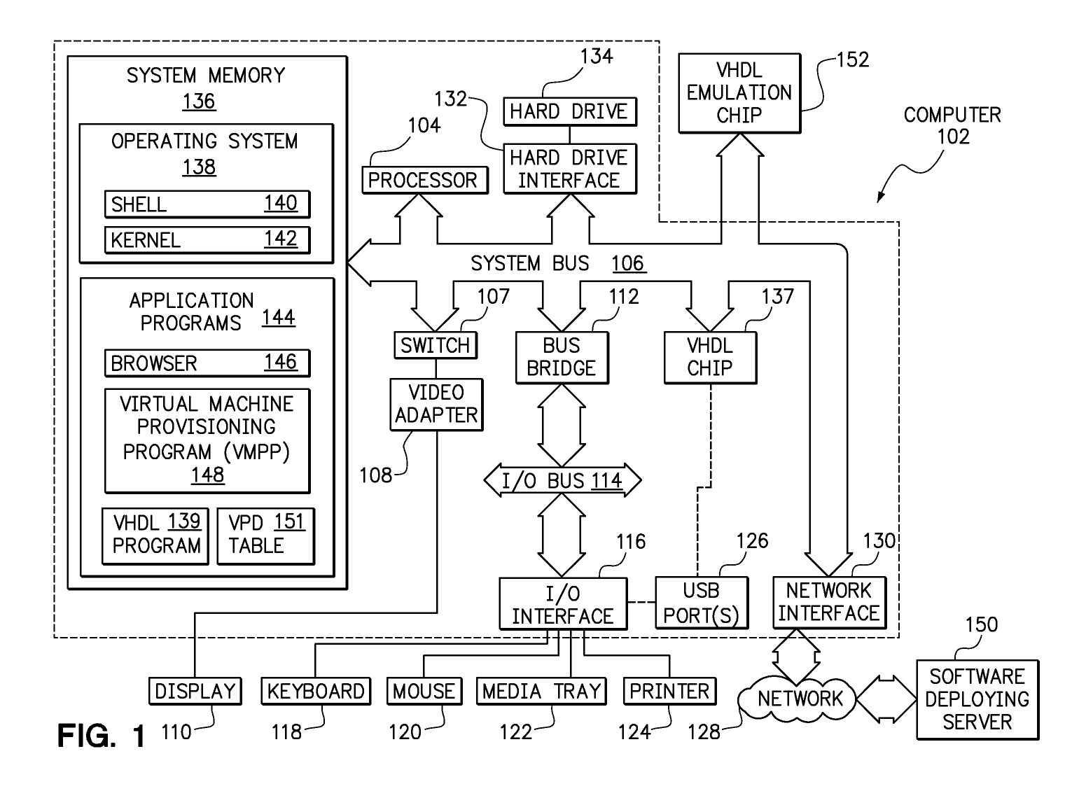

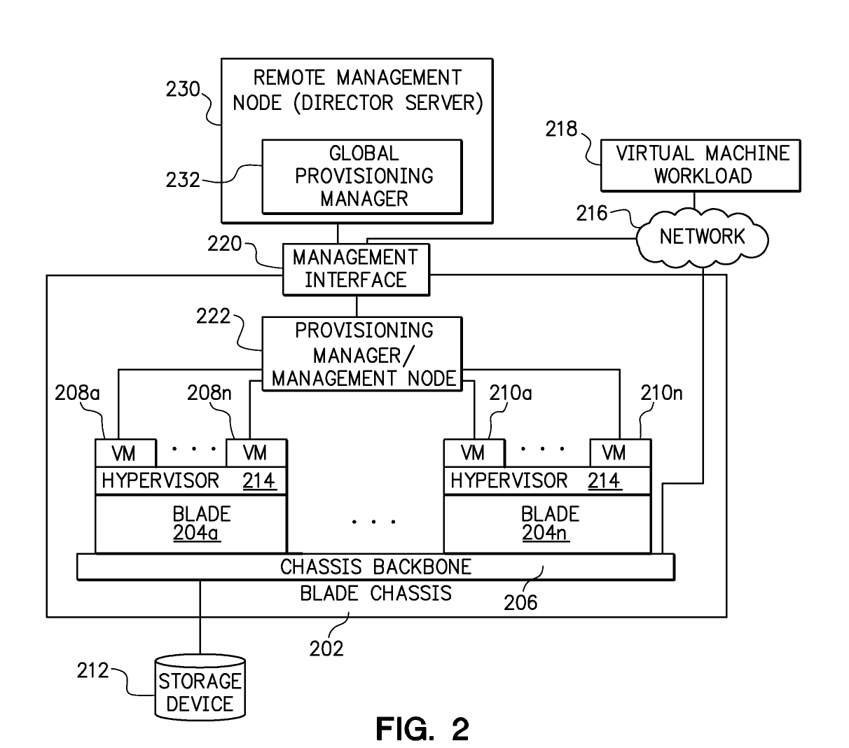

With reference now to the figures, FIG. 1 is a block diagram of an exemplary computer 102, which may be utilized by the present invention. Note that some or all of the exemplary architecture, including both depicted hardware and software, shown for and within computer 102 may be utilized by software deploying server 150, as well as provisioning manager/management node 222, and server blades 204a-n shown below in FIG. 2 and FIG. 6. Note that while blades described in the present disclosure are described and depicted in exemplary manner as server blades in a blade chassis, some or all of the computers described herein may be stand-alone computers, servers, or other integrated or stand-alone computing devices. Thus, the terms “blade,” “server blade,” “computer,” “server,” and “compute node” are used interchangeably in the present descriptions.

Computer 102 includes a processor unit 104 that is coupled to a system bus 106. Processor unit 104 may utilize one or more processors, each of which has one or more processor cores. A video adapter 108, which drives/supports a display 110, is also coupled to system bus 106. In one embodiment, a switch 107 couples the video adapter 108 to the system bus 106. Alternatively, the switch 107 may couple the video adapter 108 to the display 110. In either embodiment, the switch 107 is a switch, preferably mechanical, that allows the display 110 to be coupled to the system bus 106, and thus to be functional only upon execution of instructions (e.g., virtual machine provisioning program—VMPP 148 described below) that support the processes described herein.

System bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a printer 124, and (if a VHDL chip 137 is not utilized in a manner described below) external USB port(s) 126. While the format of the ports connected to I/O interface 116 may be any known to those skilled in the art of computer architecture, in a preferred embodiment some or all of these ports are universal serial bus (USB) ports.

As depicted, the computer 102 is able to communicate with a software deploying server 150 via network 128 using a network interface 130. The network 128 may be an external network such as the Internet, or an internal network such as an Ethernet or a virtual private network (VPN).

A hard drive interface 132 is also coupled to the system bus 106. The hard drive interface 132 interfaces with a hard drive 134. In a preferred embodiment, the hard drive 134 communicates with a system memory 136, which is also coupled to the system bus 106. System memory is defined as a lowest level of volatile memory in the computer 102. This volatile memory includes additional higher levels of volatile memory (not shown), including, but not limited to, cache memory, registers and buffers. Data that populates the system memory 136 includes the operating system (OS) 138 and application programs 144 of the computer 102.

The operating system 138 includes a shell 140 for providing transparent user access to resources such as application programs 144. Generally, the shell 140 is a program that provides an interpreter and an interface between the user and the operating system. More specifically, the shell 140 executes commands that are entered into a command line user interface or from a file. Thus, the shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while the shell 140 is a text-based, line-oriented user interface, the present invention will equally well support other user interface modes, such as graphical, voice, gestural, etc.

As depicted, the operating system 138 also includes kernel 142, which includes lower levels of functionality for the operating system 138, including providing essential services required by other parts of the operating system 138 and application programs 144, including memory management, process and task management, disk management, and mouse and keyboard management.

The application programs 144 include an optional renderer, shown in exemplary manner as a browser 146. The browser 146 includes program modules and instructions enabling a world wide web (WWW) client (i.e., computer 102) to send and receive network messages to the Internet using hypertext transfer protocol (HTTP) messaging, thus enabling communication with software deploying server 150 and other described computer systems.

Application programs 144 in the system memory of the computer 102 (as well as the system memory of the software deploying server 150) also include a virtual machine provisioning program (VMPP) 148. The VMPP 148 includes code for implementing the processes described below, including those described in FIGS. 2-6. The VMPP 148 is able to communicate with a vital product data (VPD) table 151, which provides required VPD data described below. In one embodiment, the computer 102 is able to download the VMPP 148 from software deploying server 150, including in an on-demand basis. Note further that, in one embodiment of the present invention, the software deploying server 150 performs all of the functions associated with the present invention (including execution of VMPP 148), thus freeing the computer 102 from having to use its own internal computing resources to execute the VMPP 148.

Optionally also stored in the system memory 136 is a VHDL (VHSIC hardware description language) program 139. VHDL is an exemplary design-entry language for field programmable gate arrays (FPGAs), application specific integrated circuits (ASICs), and other similar electronic devices. In one embodiment, execution of instructions from VMPP 148 causes VHDL program 139 to configure VHDL chip 137, which may be an FPGA, ASIC, etc.

In another embodiment of the present invention, execution of instructions from the VMPP 148 results in a utilization of the VHDL program 139 to program a VHDL emulation chip 152. The VHDL emulation chip 152 may incorporate a similar architecture as described above for VHDL chip 137. Once VMPP 148 and VHDL program 139 program the VHDL emulation chip 152, VHDL emulation chip 152 performs, as hardware, some or all functions described by one or more executions of some or all of the instructions found in VMPP 148. That is, the VHDL emulation chip 152 is a hardware emulation of some or all of the software instructions found in VMPP 148. In one embodiment, VHDL emulation chip 152 is a programmable read only memory (PROM) that, once burned in accordance with instructions from VMPP 148 and VHDL program 139, is permanently transformed into a new circuitry that performs the functions needed to perform the process described below in FIGS. 2-6.

The hardware elements depicted in computer 102 are not intended to be exhaustive, but rather are representative to highlight essential components required by the present invention. For instance, computer 102 may include alternate memory storage devices such as magnetic cassettes, digital versatile disks (DVDs), Bernoulli cartridges, and the like. These and other variations are intended to be within the spirit and scope of the present invention.

FIG. 2 is a diagram of an exemplary blade chassis 202 operating as a “cloud” environment for a pool of resources. Blade chassis 202 comprises a plurality of blades 204a-n (where “n” is an integer) coupled to a chassis backbone 206. Each blade is able to support one or more virtual machines (VMs). As known to those skilled in the art of computers, a VM is a software implementation (emulation) of a physical computer. A single physical computer (blade) can support multiple VMs, each running the same, different, or shared operating systems. In one embodiment, each VM can be specifically tailored and reserved for executing software tasks 1) of a particular type (e.g., database management, graphics, word processing etc.); 2) for a particular user, subscriber, client, group or other entity; 3) at a particular time of day or day of week (e.g., at a permitted time of day or schedule); etc.

As shown in FIG. 2, the blade 204a supports a plurality of VMs 208a-n (where “n” is an integer), and the blade 204n supports a further plurality of VMs 210a-n (wherein “n” is an integer). The blades 204a-n are coupled to a storage device 212 that provides a hypervisor 214, guest operating systems, and applications for users (not shown). Provisioning software from the storage device 212 is loaded into the provisioning manager/management node 222 to allocate virtual machines among the blades in accordance with various embodiments of the invention described herein. The computer hardware characteristics are communicated from the VPD 151 to the VMPP 148 (per FIG. 1). The VMPP may communicate the computer physical characteristics to the blade chassis provisioning manager 222 to the management interface 220 through the network 216, and then to the Virtual Machine Workload entity 218.

Note that chassis backbone 206 is also coupled to a network 216, which may be a public network (e.g., the Internet), a private network (e.g., a virtual private network or an actual internal hardware network), etc. Network 216 permits a virtual machine workload 218 to be communicated to a management interface 220 of the blade chassis 202. This virtual machine workload 218 is a software task whose execution is requested on any of the VMs within the blade chassis 202. The management interface 220 then transmits this workload request to a provisioning manager/management node 222, which is hardware and/or software logic capable of configuring VMs within the blade chassis 202 to execute the requested software task. In essence the virtual machine workload 218 manages the overall provisioning of VMs by communicating with the blade chassis management interface 220 and provisioning management node 222. Then this request is further communicated to the VMPP 148 in the generic computer system (See FIG. 1). Note that the blade chassis 202 is an exemplary computer environment in which the presently disclosed system can operate. The scope of the presently disclosed system should not be limited to merely blade chassis, however. That is, the presently disclosed method and process can also be used in any computer environment that utilizes some type of workload management, as described herein. Thus, the terms “blade chassis,” “computer chassis,” and “computer environment” are used interchangeably to describe a computer system that manages multiple computers/blades/servers.

FIG. 2 also shows an optional remote management node 230, such as an IBM Director Server, in accordance with a further embodiment of the invention. The remote management node 230 is in communication with the chassis management node 222 on the blade chassis 202 via the management interface 220, but may communicate with any number of blade chassis and servers. A global provisioning manager 232 is therefore able to communicate with the (local) provisioning manager 222 and work together to perform the methods of the present invention. The optional global provisioning manager is primarily beneficial in large installations having multiple chassis or racks of servers, where the global provisioning manager can coordinate inter-chassis migration or allocation of VMs.

The global provisioning manager preferably keeps track of the VMs of multiple chassis or multiple rack configurations. If the local provisioning manager is able, that entity will be responsible for migrating VMs within the chassis or rack and send that information to the global provisioning manager. The global provisioning manager would be involved in migrating VMs among multiple chassis or racks, and perhaps also instructing the local provisioning management to migrate certain VMs. For example, the global provisioning manager 232 may build and maintain a table containing the same VM data as the local provisioning manager 222, except that the global provisioning manager would need that data for VMs in each of the chassis or racks in the multiple chassis or multiple rack system. The tables maintained by the global provisioning manager 232 and each of the local provisioning managers 222 would be kept in sync through ongoing communication with each other. Beneficially, the multiple tables provide redundancy that allows continued operation in case one of the provisioning managers stops working.

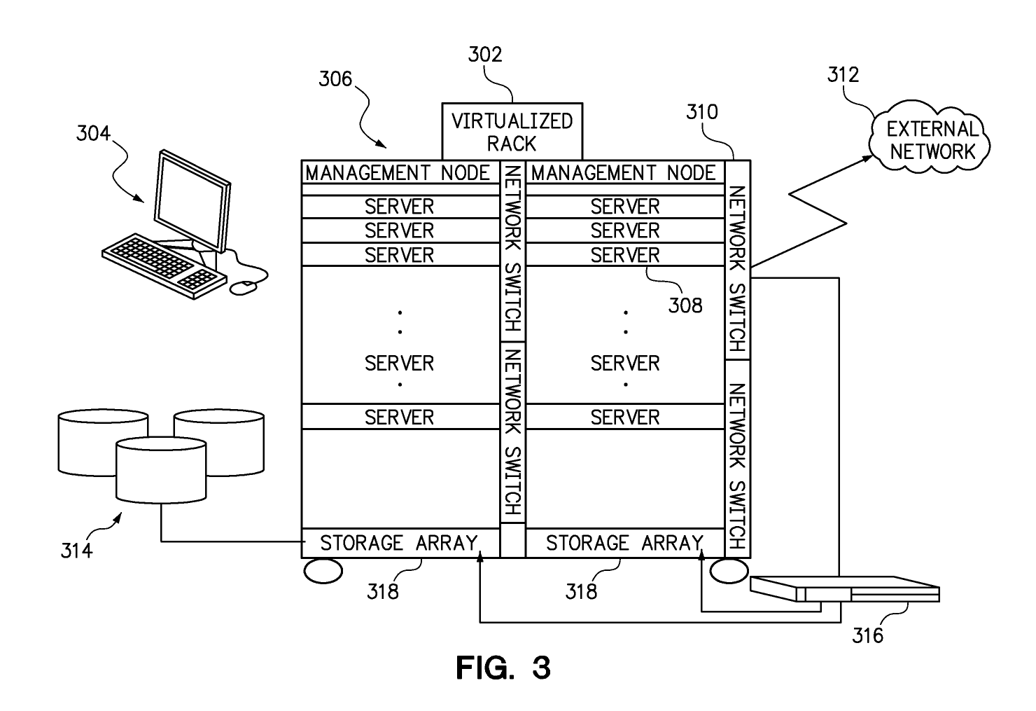

FIG. 3 presents one embodiment of the present invention with multiple physical servers in a 19-inch rack environment. This configuration is similar to the configuration 202 shown in FIG. 2 except FIG. 3 depicts a virtualized rack 302. A user 304 is able to transmit a request for execution of a software task to a management node 306 (analogous to provisioning manager/management node 222 shown in FIG. 2). Based on the I/O capabilities of a particular server 308 and its coupled network switch 310 to communicate with the external network 312 and storage devices 314 (via gateway 316 and virtualized storage arrays 318), the user's request is addressed to the appropriate and optimal computer (e.g., server 308). The virtualized rack 302 is, for example, a blade chassis holding multiple servers. Each physical server (including server 308) has I/O network adapters to support input/output traffic. To determine the optimal number of virtual machines able to execute on the server, the provisioning manager must be able to retrieve the network configuration of the physical server (I/O capability) and coordinate this information to properly provision VMs on each of the servers.

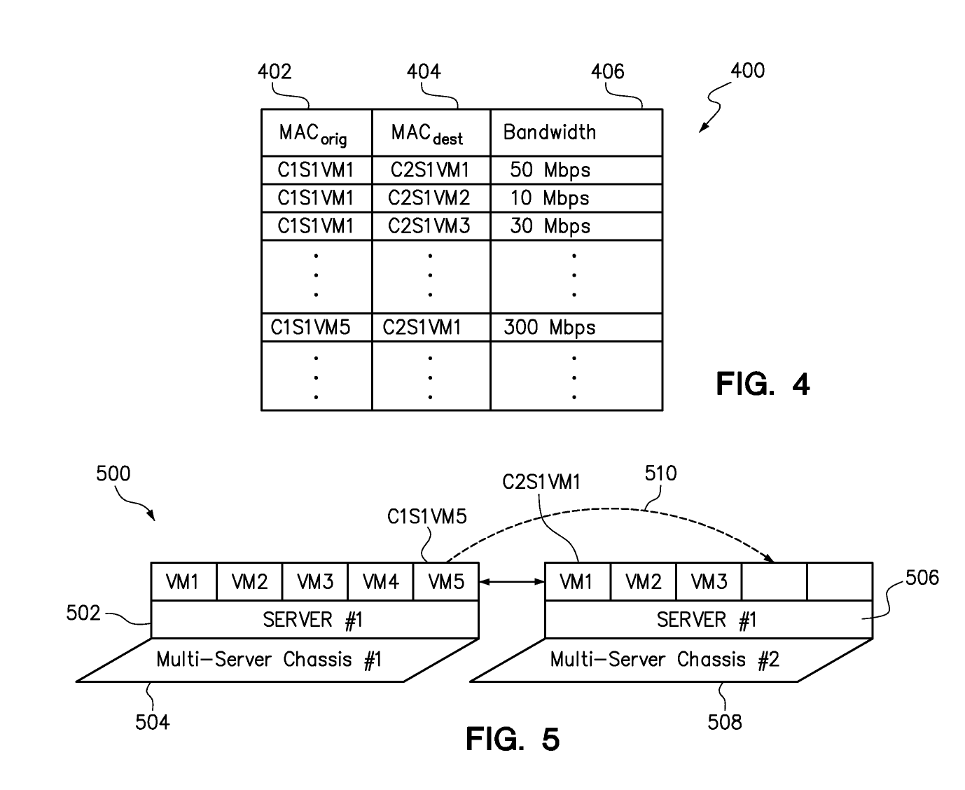

FIG. 4 is a table 400 illustrating one embodiment of the network traffic data that may be obtained from the MIB of network switches and maintained by a management node. As shown, the first column 402 lists a virtual machine that originates a communication and identifies the virtual machine by a unique MAC address. For the purpose of illustration, the MAC address is represented by a label that collectively comprises a chassis number, server number and virtual machine number. For example, in the first row of the table below the header, the virtual machine ID “C1S1VM1” refers to a virtual machine #1 on a server #1 in a chassis #1. The second column 404 lists a virtual machine that is the destination of the communication. Accordingly, the two virtual machines identified in a single row may be referred to as a couplet, and the bandwidth set out in the third column 406 is the amount of inter-VM network traffic (in units of Megabits per second (Mpbs)) attributable to communication from one virtual machine to another. The first row of the table shows that the inter-VM network bandwidth of communications from C1S1VM1 to C2S1VM1 averages 50 Mbps. The MIB may also contain an entry for inter-VM network traffic in the reverse direction between the couplet, such as from C2S1VM1 to C1S1VM1 (data entry not shown). However, some virtual machines, such as a VM that is running a CADD program, the inter-VM network traffic may be substantially all in one direction. Embodiment of the present invention may be based upon either uni-directional or bi-directional bandwidth. For the purpose of determining whether or not a server has sufficient unused resources to receive migration of a virtual machine, the table 400 might further include the processor utilization and memory utilization of each virtual machine.

Only a portion of the table is shown, including network traffic originating from virtual machine ID C1S1VM1 directed to three different virtual machines (C2S1VM1, C2S1VM2, and C2S1VM3) on server 1 of chassis 2, and network traffic originating from virtual machine ID C1S1VM5 directed to a single virtual machine (C2S1VM1) on server 1 of chassis 2. Server 1 of chassis 1 and server 1 of chassis 2 can communicate with each other, as well as with the global provisioning manager, over a network switch.

Periodically, the remote management node will gather data from the MIBs of each network switch in the entire network. To ensure network stability, the remote management node preferably averages the traffic for a specific period of time prior to making a decision to migrate a virtual machine. Once a VM-to-VM couplet (pair) has been identified having network bandwidth above a threshold level, the remote management node will determine whether the physical server of either VM in the couplet has the resources to receive the other VM, or whether both VMs must be migrated to a different physical server in order from both VMs of the couplet to reside on the same physical server. In the example in FIG. 4, chassis 1, server 1 VM5, (C1S1VM5) is moved to chassis 2, server 1 because there is enough processing capacity. (The remote management node has deployed the VM images and has previously determined the processing and memory capacity of each physical server). Migrating the single VM (C1S1VM5) in this example would be expected to eliminate an average of 300 Mbps of network bandwidth until the processes of the inter-VM couplet are complete. While the two server system represented by the table 400 in FIG. 4 is quite small, this example is representative of two servers in a system having any number of servers in any number of chassis.

To prepare the table 400, the provisioning manager sends a request for management information base (MIB) statistics to each network switch. For example, the request may be in the form of a simple network management protocol (SNMP) GET request/command (i.e., SNMP GET MIB Stats). The switch responds with the requested statistics, such as with a SNMP PUT (i.e., SNMP PUT MIB Stats). The MIB Stats allow the provisioning manager to build or populate the table to include the bandwidth being used by each virtual machine. Additional SNMP PUT MIB Stats may be communicated from each switch to the provisioning manager for each of the other virtual machines on each server.

As previously mentioned, the local or global provisioning manager will preferably average the inter-VM network traffic over a period of time to ensure that a momentary peak does not result in a migration of a VM. Similarly, the local or global provisioning manager will preferably use a hysteresis algorithm to avoid continuous movement of VMs across the network and ensure network stability by allowing VMs to remain on the same physical server for a period of time.

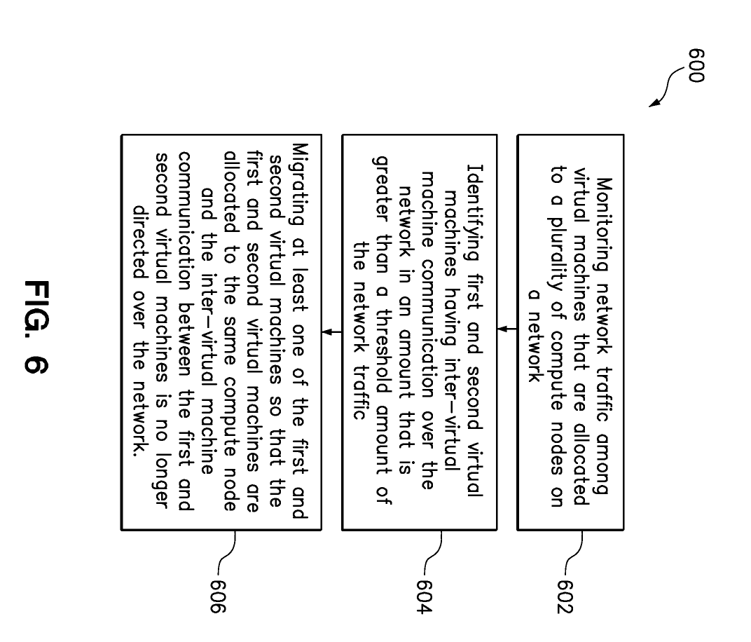

FIG. 5 is a block diagram of a system 500 illustrating the migration of a virtual machine represented in table 400 of FIG. 4 from one server to another. The migration of the virtual machine C1S1VM5 from server 1 (502) of chassis 1 (504) to server 1 (506) of chassis 2 (508) is represented by the arrow (518). As a result of the migration, the VM couplet of C1S1VM5 and C2S1VM1 will be on the same physical server 506 and the average of 300 Mbps inter-VM network traffic attributable to that VM couplet will be eliminated.

FIG. 6 is a flowchart of a computer implemented method 600. Step 602 includes monitoring network traffic among virtual machines that are allocated to a plurality of compute nodes on a network. In step 604, first and second virtual machines are identified having inter-virtual machine communication over the network in an amount that is greater than a threshold amount of the network traffic. Then, step 606 include migrating at least one of the first and second virtual machines so that the first and second virtual machines are allocated to the same compute node and the inter-virtual machine communication between the first and second virtual machines is no longer directed over the network.

In a separate example, it may occur that a VM1 and a VM2 are on a first compute node having high inter-VM communication (not over the network) and VM2 is also having high inter-VM communication with a VM3 on a second computer node (over the network). In such a situation, embodiments of the invention may determine that VM2 should be migrated to the second compute node to eliminate the network traffic associated with the VM2-VM3 communication. However, in this example the migration of VM2 to the second compute node will inadvertently generate new network traffic associated with the VM1-VM2 communication since VM1 and VM2 will no longer be on the same physical compute node. However, a subsequent iteration of the analysis of inter-VM network bandwidth would identify this new inter-VM network bandwidth in the MIB. Accordingly, the VM couplet with the highest inter-VM bandwidth would be identified and further migrations would take place. Over time and iterations of the present methods, if the VM1-VM2 network bandwidth was consuming significant bandwidth, such as becoming the VM couplet with the highest network bandwidth, then one of VM1 and VM2 would be moved so that VM1 and VM2 would again be on the same compute node. Preferably, the method will include a hysteresis function that will prevent a repetitive back and forward migration of VMs. In this example, the migration of VM2 to the second compute node should initiate a time period over which VM2 should not be further migrated back to the first compute node. As a result, if and when the network bandwidth of the VM1-VM2 communication needs to be eliminated, the method would consider that VM2 should not be migrated to the first compute node (i.e, avoid a reserve migration) and will attempt to move VM1 instead. Should the second compute node have insufficient resources to receive VM1, then both VM1 and VM2 may be move to a third compute node. Therefore, over time and multiple iterations of the method, if there are multiple VMs that have high inter-VM communication, these VMs should end up together on the same physical compute node, such that the method would reach a point of stability on moving VMs.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in one or more computer-readable storage medium having computer-usable program code stored thereon.

Any combination of one or more computer usable or computer readable storage medium(s) may be utilized. The computer-usable or computer-readable storage medium may be, for example but not limited to, an electronic, magnetic, electromagnetic, or semiconductor apparatus or device. More specific examples (a non-exhaustive list) of the computer-readable medium include: a portable computer diskette, a hard disk, random access memory (RAM), read-only memory (ROM), an erasable programmable read-only memory (EPROM or Flash memory), a portable compact disc read-only memory (CD-ROM), an optical storage device, or a magnetic storage device. The computer-usable or computer-readable storage medium could even be paper or another suitable medium upon which the program is printed, as the program can be electronically captured via, for instance, optical scanning of the paper or other medium, then compiled, interpreted, or otherwise processed in a suitable manner, if necessary, and then stored in a computer memory. In the context of this document, a computer-usable or computer-readable storage medium may be any storage medium that can contain or store the program for use by a computer. Computer usable program code contained on the computer-usable storage medium may be communicated by a propagated data signal, either in baseband or as part of a carrier wave. The computer usable program code may be transmitted from one storage medium to another storage medium using any appropriate transmission medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable storage medium that can direct a computer or other programmable data processing apparatus to function in a particular manner, such that the instructions stored in the computer-readable storage medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer implemented method, comprising:
monitoring network traffic among virtual machines that are allocated to a plurality of compute nodes on a network;
identifying first and second virtual machines having inter-virtual machine communication over the network in an amount that is greater than a threshold amount of the network traffic; and
migrating at least one of the first and second virtual machines so that the first and second virtual machines are allocated to the same compute node and the inter-virtual machine communication between the first and second virtual machines is no longer directed over the network.

2. The computer implemented method of claim 1, wherein the compute node is coupled to an Ethernet link of a network switch, the method further comprising:
obtaining data from a management information database of the network switch to determine the amount of network bandwidth through the Ethernet link that is being utilized for communication between the first and second virtual machines.

3. The computer implemented method of claim 10, wherein the amount of network bandwidth attributable to communications between the first and second virtual machines is identified according to media access control addresses or Internet Protocol addresses that are assigned to the first and second virtual machines.

4. The computer implemented method of claim 1, wherein migrating at least one of the first and second virtual machines includes migrating the first virtual machine from a first compute node to a second compute node that is running the second virtual machine.

5. The computer implemented method of claim 1, wherein migrating at least one of the first and second virtual machines includes migrating both the first and second virtual machines to a compute node.

6. The computer implemented method of claim 1, further comprising:
calculating a value that is representative of the inter-virtual machine communication between the first and second virtual machines over a period of time; and
wherein the identifying of first and second virtual machines includes identifying first and second virtual machines having a representative value of inter-virtual machine communication that is greater than a threshold value.

7. The computer implemented method of claim 6, wherein the calculated value is selected from an average, mean, and standard deviation.

8. The computer implemented method of claim 1, further comprising:
ranking the virtual machines having the highest inter-virtual machine communication.

9. The computer implemented method of claim 4, further comprising:
determining that the second compute node has sufficient unused resources to operate the first virtual machine.

10. The computer implemented method of claim 9, wherein determining an amount of unused resources includes:
reading the vital product data of the compute node to determine the input/output capacity, the processor capacity, and the memory capacity of the compute node.

11. The computer implemented method of claim 9, wherein determining an amount of unused resources includes:
obtaining the processor utilization and the memory utilization directly from the compute node.

12. The computer implemented method of claim 1, further comprising:
determining an amount of unused resources on a first compute node operating the first virtual machine and an amount of unused resources on a second compute node operation the second virtual machine;
determine the resource requirements of the first and second virtual machines; and
selecting between migrating the first virtual machine to the second compute node and migrating the second virtual machine to the first compute node so that the utilization of resources after migration is most evenly distributed between the first and second compute node.

13. The computer implemented method of claim 10, wherein determining an amount of unused resources includes:
reading the vital product data of the compute node to determine the input/output capacity, the processor capacity, and the memory capacity of the compute node.

14. The computer implemented method of claim 10, wherein determining an amount of unused resources includes:
obtaining the processor utilization and the memory utilization directly from the compute node.

15. The computer implemented method of claim 1, wherein the threshold amount of the network traffic is a threshold percentage of the link bandwidth.
